(19) United States
(12) Patent Application Publication
(10) Pub. No.: US 2014/0153753 A1
(43) Pub. Date: Jun. 5, 2014

(54) Object Based Audio Rendering Using Visual Tracking of at Least One Listener

(71) Applicant: Dolby Laboratories Licensing Corporation, San Francisco, CA (US)

(72) Inventor: Brett G. Crockett, Brisbane, CA (US)

(73) Assignee: DOLBY LABORATORIES LICENSING CORPORATION, San Francisco, CA (US)

(21) Appl. No.: 14/095,901

(22) Filed: Dec. 3, 2013

Related U.S. Application Data
(60) Provisional application No. 61/733,021, filed on Dec. 4, 2012.

(51) Int. Cl. H04S 7/00

(52) U.S. Cl. CPC H04S 7/00
USPC 381/307

(57) ABSTRACT

In some embodiments, a method and system for generating image data, processing the image data to generate listener data indicative of at least one listener characteristic (e.g., position and/or size of each listener), and rendering at least one audio object (e.g., rendering an object based audio program) in response to the listener data (and optionally also listener identification data). For rendering a program indicative of audio objects, at least one speaker feed may be generated for driving at least one speaker to emit sound indicative of one of the objects and additional sound indicative of another one of the objects, where the sound is intended to be perceived by a listener at a first position with balance and delay appropriate to the first position, and the additional sound is intended to be perceived by a listener at a second position with balance and delay appropriate to the second position.

### CROSS REFERENCE TO RELATED APPLICATIONS

This application claims the benefit of U.S. Provisional Application No. 61/733,021 filed Dec. 4, 2012, which is hereby incorporated by reference in its entirety.

### TECHNICAL FIELD

The invention relates to systems and methods for employing visual tracking of at least one listener characteristic (e.g., position of a listener) to control rendering of object based audio (i.e., audio data indicative of an object based audio program). In some embodiments, the invention is a system and method for rendering object based audio including by generating speaker feeds for driving loudspeakers, in response to feedback from visual tracking of at least one listener characteristic.

### BACKGROUND

Conventional channel-based audio encoders typically operate under the assumption that each audio program (that is output by the encoder) will be reproduced by an array of loudspeakers in predetermined positions relative to a listener. Each channel of the program is a speaker channel. This type of audio encoding is commonly referred to as channel-based audio encoding.

Another type of audio encoder (known as an object-based audio encoder) implements an alternative type of audio coding known as audio object coding (or object based coding and operates under the assumption that each audio program (that is output by the encoder) may be rendered for reproduction by any of a large number of different arrays of loudspeakers. Each audio program output by such an encoder is an object based audio program, and typically, each channel of such object based audio program is an object channel. In audio object coding, audio signals associated with distinct sound sources (audio objects) are input to the encoder as separate audio streams. Examples of audio objects include (but are not limited to) a dialog track, a single musical instrument, and a jet aircraft. Each audio object is associated with spatial parameters, which may include (but are not limited to) source position, source width, and source velocity and/or trajectory. The audio objects and associated parameters are encoded for distribution and storage. Final audio object mixing and rendering is performed at the receive end of the audio storage and/or distribution chain, as part of audio program playback. The step of audio object mixing and rendering is typically based on knowledge of actual positions of loudspeakers to be employed to reproduce the program.

Typically, during generation of an object based audio program, the content creator embeds the spatial intent of the mix (e.g., the trajectory of each audio object determined by each object channel of the program) by including metadata in the program. The metadata can be indicative of the position or trajectory of each audio object determined by each object channel of the program, and/or at least one of the size, velocity, type (e.g., dialog or music), and another characteristic of each such object.

During rendering of an object based audio program, each object channel can be rendered “at” a position (e.g., a time-varying position having a desired trajectory) by generating speaker feeds indicative of content of the channel and applying the speaker feeds to a set of loudspeakers (where the physical position of each of the loudspeakers may or may not coincide with the desired position at any instant of time). The speaker feeds for a set of loudspeakers may be indicative of content of multiple object channels (or a single object channel). The rendering system typically generates the speaker feeds to match the exact hardware configuration of a specific reproduction system (e.g., the speaker configuration of a home theater system, where the rendering system is also an element of the home theater system).

One common problem with conventional reproduction of audio (e.g., in the home) is what is known as the precedence effect. In accordance with the precedence effect, if a sound signal arrives time delayed at a listener from different directions, with different time delays depending on arrival direction, the first arriving sound signal is perceived as being more prominent and/or louder. Audio is typically mixed and rendered assuming the listener is sitting in an ideal location, sometimes called the “sweet spot.” For stereo reproduction this is exactly between the two speakers and for surround sound reproduction this is located directly in the center of the surround sound system. As a listener moves away from the ideal location, the perceived audio is spatially distorted because as the user moves closer to one or more speakers, the sound emitted by the nearer speakers is perceived as being louder and the intended balance of the mix is disturbed.

The inventor has recognized that the problems noted in the previous paragraph exist during rendering of object based audio programs. Specifically, the inventor has recognized that when a listener moves away from the ideal listener location assumed by an object based audio rendering system, the audio (as rendered by the system in response to an object based audio program) perceived by the listener is spatially distorted relative to the audio that he or she would perceive if he or she remained at the ideal location. In order to overcome such problems, typical embodiments of the present invention employ visual tracking of the position of a listener (or the position of each of two or more listeners) to control rendering of an object based audio program

The inventor has also recognized that by employing visual tracking of at least one listener characteristic (e.g., listener size, position, or motion) to control rendering of an object based audio program, the object based audio program can be rendered in a wide variety of new ways that had not been possible prior to the present invention (e.g., to provide next generation audio reproduction experiences to each listener).

Many popular home devices such as gaming consoles and some televisions have complex built-in visual systems which could be used (in accordance with the present invention) to control rendering of audio programs. For example, popular gaming systems such as the Xbox and PS3 systems have sophisticated visual analysis components that can identify the presence and location of one or more people in a room. For the Xbox system, the visual analysis component is the Kinect system. For the PS3 system, it is the PlayStation® Eye Camera system. The present inventor has recognized that the output of each camera of such a home device could be processed in novel ways in accordance with the present invention to control, automatically and dynamically (e.g., in sophisticated ways), the rendering of object based audio for playback in the camera field of view.

### BRIEF DESCRIPTION OF EXEMPLARY EMBODIMENTS

In a class of embodiments, the invention is a method and system for rendering an audio program comprising (e.g., indicative of) one or more audio objects (e.g., an object based audio program) for playback in an environment including a speaker array, including by visually tracking at least one listener in the environment to generate listener data indicative of at least one listener characteristic (e.g., position of a listener), and rendering an object based audio program in response to the listener data. Typically, the method includes steps of generating image data (i.e., the output of at least one camera) indicative of at least one listener in an environment, said environment including a speaker array comprising at least one speaker, processing the image data to generate listener data indicative of at least one listener characteristic (e.g., the position and/or size of each listener in the field of view of at least one camera), and rendering at least one of the objects (e.g., rendering an object based audio program) in response to the listener data (e.g., including by generating at least one speaker feed for driving at least one speaker of the array to emit sound intended to be perceived as emitting from at least one source determined by the program). Typically, the program is an object based audio program, each channel of the object based audio program is an object channel, the program includes metadata (e.g., content type metadata), and the metadata is used with the listener data to control object based audio rendering.

Some embodiments of the inventive method and system are implemented to use not only the listener data, but also detailed information (determined from the audio program itself, including the program's metadata) about the program content, the author's intent, and the program's audio objects, to render the program in any of a wide variety of ways (e.g., to provide next generation audio reproduction experiences to each listener).

The invention has many applications. For example, some embodiments of the invention are implemented in a gaming system (which includes a gaming console, a display device, a camera subsystem, and a speaker array) or in a home theater system including a television (or other display device), a camera subsystem, and a speaker array.

In a class of embodiments, the inventive system includes a camera subsystem (including at least one camera) configured to generate image data indicative of at least one listener in the field of view of at least one camera of the camera subsystem, a visual tracking subsystem coupled and configured to process the image data to generate listener data indicative of at least one listener characteristic (e.g., the position of each listener in the field of view of at least one camera of the camera subsystem), and a rendering subsystem coupled and configured to render an audio program comprising (e.g., indicative of) one or more audio objects (e.g., an object based audio program) in response to the listener data (e.g., including by generating speaker feeds for driving a set of loudspeakers to emit sound intended to be perceived as emitting from at least one source determined by the program). In some embodiments, the rendering subsystem is configured (e.g., is or includes a processor programmed or otherwise configured) to render at least one of the objects (e.g., to render an object based audio program) in response to metadata regarding (e.g., included in) the program and in response to the listener data.

By coupling a visual tracking system to an object based audio rendering system in accordance with the invention, listener data generated by the tracking system can be used by the rendering system to compensate for spatial distortion of perceived audio due to movement of a listener. For example if in a stereo playback environment, the listener moves from the center of a couch (e.g., at the ideal listening location assumed by the rendering system) to the left side of the couch, nearer to the left speaker, the system would detect this movement and compensate the level and delay of the output of the left and right speakers to provide the listener at the new location with an ideal playback experience. Such compensation for listener movement is also possible with a surround sound system.

For another example, a movie soundtrack which is an object based audio program may have separate audio objects for dialog and music (as well as the other audio elements). During playback of the soundtrack, the visual tracking subsystem of an exemplary embodiment of the inventive system is configured to detect the presence of a small person near to a right speaker (the small person is identified to, or assumed by, the system to be a child) and the presence of a larger person (the larger person is identified to the system as an elderly person with hearing loss) relatively far from the right speaker. In response to the listener data (indicative of the child's position and the adult's position) generated by the visual tracking subsystem, the system dynamically renders the audio so that the dialog (an audio object indicated by the program) is processed and enhanced using audio processing tools such as dialog enhancement and mixed more to the left side of the room (away from the right speaker) for the adult. The visual tracking subsystem could also identify that the child is dancing to the music and mix the music (another object indicated by the program) more towards the right side of the room, toward the child and away from the adult to prevent the music from interfering with the adult's ability to understand the dialog.

Typically, the listener data generated in accordance with the invention is indicative of position of at least one listener, and the inventive system is preferably configured to render an object based audio program indicative of at least two audio objects (e.g., dialog and music), including by generating speaker feeds for driving a set of loudspeakers to emit sound, indicative of one of the audio objects, which is intended to be perceived by one listener (at a first position indicated by the listener data) with balance and delay appropriate to a listener at the first position, and to emit sound, indicative of another one of the audio objects, which is intended to be perceived by another listener (at a second position indicated by the listener data) with balance and delay appropriate to a listener at the second position.

Many uses exist for embodiments of the inventive visually capable audio method and system for dynamic rendering of object based audio. For another example, such a system is configured to visually identify that a person sitting in a chair or couch has fallen asleep, and in response, the system could gradually turn down the audio playback level or turn off the audio (or, optionally, the system could turn itself off).

Metadata can be included in an object based audio program to provide to the inventive system information that influences the system's behavior. For example, the metadata could indicate a characteristic (e.g., a type or a property) of an audio object, and the system could be configured to operate in a specific mode in response to such metadata.

Aspects of the invention include a rendering system configured (e.g., programmed) to perform any embodiment of the inventive method, and a computer readable medium (e.g., a disc or other tangible object) which stores code for implementing any embodiment of the inventive method.

In some embodiments, the inventive system includes camera subsystem and a general or special purpose processor programmed with software (or firmware) and/or otherwise configured to perform an embodiment of the inventive method. In some embodiments, the inventive system is or includes a general purpose processor, coupled to receive input audio (and optionally also input video) and image data provided by a camera subsystem, and programmed to generate (by performing an embodiment of the inventive method) output data (e.g., output data determining speaker feeds) in response to the input audio and the image data. In other embodiments, at least a rendering subsystem of the inventive system is implemented as an appropriately configured (e.g., programmed and otherwise configured) audio digital signal processor (DSP) which is operable to generate output data (e.g., output data determining speaker feeds) in response to input audio (indicative of an object based audio program) and listener data.

### NOTATION AND NOMENCLATURE

Throughout this disclosure, including in the claims, the expression performing an operation “on” signals or data (e.g., filtering, scaling, or transforming the signals or data) is used in a broad sense to denote performing the operation directly on the signals or data, or on processed versions of the signals or data (e.g., on versions of the signals that have undergone preliminary filtering prior to performance of the operation thereon).

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X-M inputs are received from an external source) may also be referred to as a decoder system.

Throughout this disclosure including in the claims, the following expressions have the following definitions:

speaker and loudspeaker are used synonymously to denote any sound-emitting transducer. This definition includes loudspeakers implemented as multiple transducers (e.g., woofer and tweeter);

speaker feed: an audio signal to be applied directly to a loudspeaker, or an audio signal that is to be applied to an amplifier and loudspeaker in series;

channel (or “audio channel”): a monophonic audio signal;

speaker channel (or “speaker-feed channel”): an audio channel that is associated with a named loudspeaker (at a desired or nominal position), or with a named speaker zone within a defined speaker configuration. A speaker channel is rendered in such a way as to be equivalent to application of the audio signal directly to the named loudspeaker (at the desired or nominal position) or to a speaker in the named speaker zone;

object channel: an audio channel indicative of sound emitted by an audio source (sometimes referred to as an audio “object”). Typically, an object channel determines a parametric audio source description. The source description may determine sound emitted by the source (as a function of time), the apparent position (e.g., 3D spatial coordinates) of the source as a function of time, and optionally also other at least one additional parameter (e.g., apparent source size or width) characterizing the source;

audio program: a set of one or more audio channels (at least one speaker channel and/or at least one object channel) and optionally also associated metadata that describes a desired spatial audio presentation;

object based audio program: an audio program comprising a set of one or more object channels (and typically not comprising any speaker channel) and optionally also associated metadata that describes a desired spatial audio presentation (e.g., metadata indicative of a trajectory of an audio object which emits sound indicated by an object channel);

render: the process of converting an audio program into one or more speaker feeds, or the process of converting an audio program into one or more speaker feeds and converting the speaker feed(s) to sound using one or more loudspeakers (in the latter case, the rendering is sometimes referred to herein as rendering “by” the loudspeaker(s)). An audio channel can be trivially rendered (“at” a desired position) by applying a speaker feed indicative of content of the channel directly to a physical loudspeaker at the desired position, or one or more audio channels can be rendered using one of a variety of virtualization techniques designed to be substantially equivalent (for the listener) to such trivial rendering. In this latter case, each audio channel may be converted to one or more speaker feeds to be applied to loudspeaker(s) in known locations, which are in general different from the desired position, such that sound emitted by the loudspeaker(s) in response to the feed(s) will be perceived as emitting from the desired position. Examples of such virtualization techniques include binaural rendering via headphones (e.g., using Dolby Headphone processing which simulates up to 7.1 channels of surround sound for the headphone wearer) and wave field synthesis. An object channel can be rendered (“at” a time-varying position having a desired trajectory) by applying speaker feeds indicative of content of the channel to a set of physical loudspeakers (where the physical position of each of the loudspeakers may or may not coincide with the desired position at any instant of time);

L: Left front audio channel. A speaker channel, typically intended to be rendered by a speaker positioned at about 30 degrees azimuth, 0 degrees elevation;

C: Center front audio channel. A speaker channel, typically intended to be rendered by a speaker positioned at about 0 degrees azimuth, 0 degrees elevation;

R: Right front audio channel. A speaker channel, typically intended to be rendered by a speaker positioned at about −30 degrees azimuth, 0 degrees elevation;

Ls: Left surround audio channel. A speaker channel, typically intended to be rendered by a speaker positioned at about 110 degrees azimuth, 0 degrees elevation;

Rs: Right surround audio channel. A speaker channel, typically intended to be rendered by a speaker positioned at about −110 degrees azimuth, 0 degrees elevation;

Full Range Channels: All audio channels of an audio program other than each low frequency effects channel of the program. Typical full range channels are L and R channels of stereo programs, and L, C, R, Ls and Rs channels of surround sound programs. The sound determined by a low frequency effects channel (e.g., a subwoofer channel) comprises frequency components in the audible range up to a cutoff frequency, but does not include frequency components in the audible range above the cutoff frequency (as do typical full range channels);

Front Channels: speaker channels (of an audio program) associated with frontal sound stage. Typical front channels are L and R channels of stereo programs, or L, C and R channels of surround sound programs; and

AVR: an audio video receiver. For example, a receiver in a class of consumer electronics equipment used to control playback of audio and video content, for example in a home theater.

### BRIEF DESCRIPTION OF THE DRAWINGS

FIG. 1 is a block diagram of a system configured to perform an embodiment of the inventive method. The system includes visual tracking subsystem 12 and rendering subsystem 14 (which may be implemented by a programmed processor) and camera 8.

### DETAILED DESCRIPTION OF EXEMPLARY EMBODIMENTS

Exemplary embodiments are systems and methods for rendering “object based audio” that has been encoded in accordance with a type of audio coding called audio object coding (or object based coding or “scene description”), and operate under the assumption that each object based audio program to be rendered may be rendered for reproduction by any of a large number of different arrays of loudspeakers. Typically, each channel of an object based audio program is an object channel. In audio object coding, audio signals associated with distinct sound sources (audio objects) are input to the encoder as separate audio streams. Examples of audio objects include (but are not limited to) a dialog track, a single musical instrument, and a jet aircraft. Each audio object is associated with spatial parameters, which may include (but are not limited to) source position, source width, and source velocity and/or trajectory. The audio objects and associated parameters are encoded for distribution and storage. Final audio object mixing and rendering may be performed at the receive end of the audio storage and/or distribution chain, as part of audio program playback. The step of audio object mixing and rendering is typically based on knowledge of actual positions (or nominal positions) of loudspeakers to be employed to reproduce the program.

Typically, during generation of an object based audio program, the content creator may embed the spatial intent of the mix (e.g., the trajectory of each audio object determined by each object channel of the program) by including metadata in the program. The metadata can be indicative of the position or trajectory of each audio object determined by each object channel of the program, and/or at least one of the size, velocity, type (e.g., dialog or music), and another characteristic of each such object.

During rendering of an object based audio program, each object channel can be rendered (“at” a time-varying position having a desired trajectory) by generating speaker feeds indicative of content of the channel and applying the speaker feeds to a set of loudspeakers (where the physical position of each of the loudspeakers may or may not coincide with the desired position at any instant of time). The speaker feeds for a set of loudspeakers may be indicative of content of multiple object channels (or a single object channel). The rendering system typically generates the speaker feeds to match the exact hardware configuration of a specific reproduction system (e.g., the speaker configuration of a home theater system, where the rendering system is also an element of the home theater system).

In the case that an object based audio program indicates a trajectory of an audio object, the rendering system would typically generate speaker feeds for driving a set of loudspeakers to emit sound intended to be perceived (and which typically will be perceived) as emitting from an audio object having said trajectory. For example, the program may indicate that sound from a musical instrument (an object) should pan from left to right, and the rendering system might generate speaker feeds for driving a 5.1 array of loudspeakers to emit sound that will be perceived as panning from the L (left front) speaker of the array to the C (center front) speaker of the array and then the R (right front) speaker of the array.

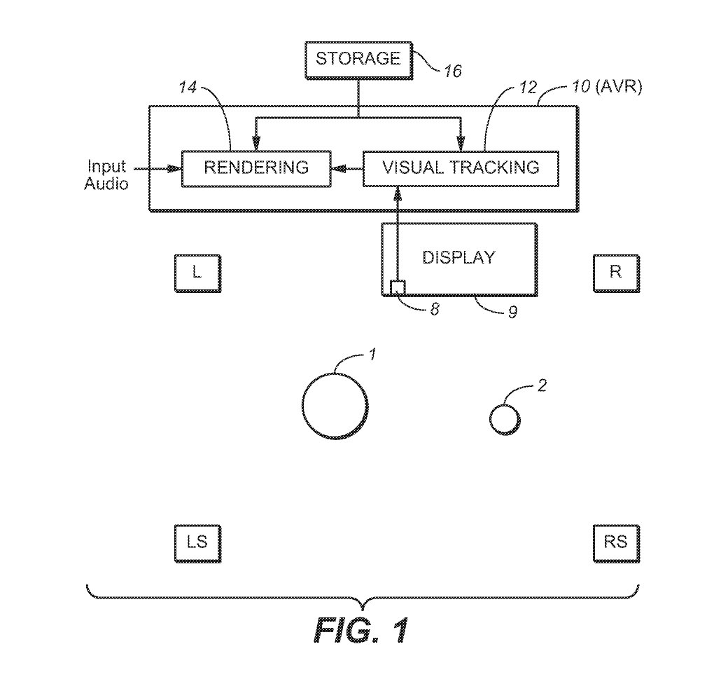

Many embodiments of the present invention are technologically possible. It will be apparent to those of ordinary skill in the art from the present disclosure how to implement them. Embodiments of the inventive system, method, and medium will be described with reference to FIG. 1. While some embodiments are directed towards methods and systems for rendering only audio object encoding, other embodiments are directed towards audio rendering methods and systems that are a hybrid between conventional channel-based rendering methods and systems, and methods and systems for object based audio rendering. For example, embodiments of the invention may render an object based audio program which includes a set of one or more object channels (with accompanying metadata) and a set of one or more speaker channels.

FIG. 1 is a block diagram of an exemplary embodiment of the inventive system, with a display device (9) and a 5.1 speaker array coupled thereto. The system of FIG. 1 includes audio video receiver (AVR) 10, and camera subsystem coupled to AVR 10. In the implementation shown in FIG. 1 the camera subsystem comprises a single camera (camera 8). The speaker array includes left front speaker L, a center front speaker, C (not shown), right front speaker, R, left surround (rear) speaker Ls, right surround (rear) speaker Rs, and a sub-woofer (not shown).

More generally, typical embodiments of the inventive system are configured to render object based audio for playback in an environment including a speaker array comprising at least one speaker and also including at least one listener. Typically, the array comprises more than one speaker (though it consists of a single speaker in some embodiments), and the array could be a 5.1 speaker array or a speaker array of another type (e.g., a speaker array consisting of headphones, or a stereo speaker array comprising two speakers).

AVR 10 is configured to render an audiovisual program including by displaying video (determined by the program) on display device 9 and driving the speaker array to play back the program's soundtrack. The soundtrack is an object based audio program indicative of at least one source (audio object). The system is configured to render the soundtrack in an environment (which may be a room) including a speaker array (e.g., the 5.1 speaker array including speakers L, R, Ls, and Rs shown in FIG. 1) and at least one listener (e.g., listeners 1 and 2, as shown in FIG. 1, in the field of view of the system's camera subsystem).

As shown in FIG. 1, listener 1 and listener 2 are present in camera 8's field of view during playback of the program in a room including a 5.1 speaker array including speakers L, R, Ls, and Rs.

Camera 8, which is typically a video camera, may be integrated with display device 9 or may be a device separate from device 9. For example, device 9 may be a television set with a built-in video camera 8. Camera 8 is coupled to visual tracking subsystem 12 of AVR 10. Camera 8 has a field of view and is configured to generate (and assert to subsystem 12) image data (e.g., video data) indicative of at least one characteristic of at least one listener in the field of view.

AVR 10 is or includes a programmed processor which implements visual tracking subsystem 12 and audio rendering subsystem 14. Subsystem 12 is configured to process the image data from camera 8 to generate listener data indicative of at least one listener characteristic. An example of such listener data is data indicative of the position of listener 1 and/or the position of listener 2 of FIG. 1 during playback of an object based audio program. Another example of such listener data is data indicative of the size of each of listeners 1 and 2, the position of each of listeners 1 and 2, and the activity of each of listeners 1 and 2 (e.g., whether the listeners are stationary or moving).

Subsystem 14 is configured to generate speaker feeds for driving the speaker array in response to the soundtrack (an object based audio program) and in response to listener data generated by subsystem 12 in response to the image data received from camera 8. Thus, the FIG. 1 system uses the listener data (and the image data) to control rendering of the soundtrack.

In variations on the FIG. 1 embodiment, the inventive system includes a visual tracking subsystem and a camera subsystem comprising two or more cameras (rather than a single camera, as in FIG. 1) each coupled to the visual tracking subsystem. The visual tracking subsystem is configured to process image data (e.g., video data) from each camera to generate listener data indicative of at least one listener characteristic.

The system of FIG. 1 optionally includes storage medium 16, which is coupled to visual tracking subsystem 12 and rendering subsystem 14. Storage medium 16 is typically a computer readable storage medium 16 (e.g., an optical disk or other tangible object) having computer code stored thereon that is suitable for programming subsystems 12 and 14 (implemented in or as a processor) to perform an embodiment of the inventive method. In operation, the processor (e.g., a processor in AVR 10 which implements subsystems 12 and 14 in software) executes the computer code to process object based input audio data, and image data from camera 8, in accordance with the invention to generate output data indicative of speaker feeds for driving the speaker array.

In some implementations, rendering subsystem 14 is configured to generate speaker feeds for driving each speaker of the 5.1 speaker array, in response to an object based audio program and listener data from visual tracking subsystem 12 indicative of knowledge of the position of each listener in camera 8's field of view. The speaker feeds are employed to driver the speakers to emit sound intended to be perceived as emitting from at least one source determined by the program.

Typically, each channel of the object based audio program is an object channel, and the program includes metadata (e.g., content type metadata) which is processed by subsystem 14 to control the object based audio rendering. A typical implementation of rendering subsystem 14 uses detailed information (determined from the program itself, including the program's metadata) about the content, the author's intent, and the audio objects of the program, and the listener data generated by subsystem 12, to render the program in any of a wide variety of ways (e.g., to provide next generation audio reproduction experiences to each listener). Metadata can be included in an object based audio program to provide to the inventive system information that influences the system's behavior. For example, the metadata could indicate a characteristic (e.g., a type or a property) of an audio object, and the rendering subsystem of the inventive system (e.g., subsystem 14 of FIG. 1) can be programmed (and/or otherwise configured) to operate in a specific mode in response to such metadata.

In one example of operation of the FIG. 1 system, subsystem 14 uses listener data (from subsystem 12) to compensate for spatial distortion of perceived audio due to movement of a listener. For example, the listener data may indicate that a listener (e.g., listener 1) has moved from the center of the room (e.g., at the ideal listening location assumed by rendering subsystem 14) to the left side of the room, nearer to left front speaker L than to right front speaker R. In response to such listener data, one implementation of subsystem 14 compensates the level and delay of the output of the left and right front speakers L and R to provide the listener at the new location with an appropriate (e.g., ideal) playback experience. For example, speaker feeds determined by the output of subsystem 14 cause the speakers to emit sound with different balance and relative delay than if the listener had not moved from the ideal location, such that the emitted sound is intended to be perceived by the listener with balance and delay appropriate to the new location of the listener (e.g., to provide the listener with at least substantially the same playback experience as the listener would have had if he or she had remained at the ideal location).

In another example, the FIG. 1 system renders a movie soundtrack which is an object based audio program indicative of separate audio objects for dialog and music (and typically also other audio elements). During playback of the soundtrack in response to speaker feeds generated by subsystem 14, listener data (from subsystem 12) indicates the presence of a small listener 2 near to right front speaker R and a larger listener 1 near to left front speaker L. In response, subsystem 14 assumes (or is informed) that the relatively small listener is a child and the relatively large listener is an adult. For example, identification data may have been asserted to subsystem 12 or 14 (at the time AVR 10 was initially instructed to play back the program) to identify two system users (listeners) as an elderly adult with hearing loss and a child, and subsystem 12 may have been configured to identify a relatively small listener (indicated by image data from camera 8) as the child and a relatively large listener (indicated by image data from camera 8) as the adult (or subsystem 14 may have been configured to identify a relatively small listener indicated by listener data from subsystem 12 as the child and a relatively large listener indicated by listener data from subsystem 12 as the adult). In response to the listener data from tracking subsystem 12, subsystem 14 dynamically renders the program so that the dialog (an audio object indicated by the program) is mixed more to the left side of the room (away from the right front speaker R) for the adult, and optionally subsystem 14 also enhances the dialog (using dialog enhancement audio processing tools which it has been preconfigured to implement). Subsystem 14 may also be configured to respond to listener data (from tracking subsystem 12) which indicate that the child is moving in response to (e.g., dancing to) the music, by mixing the music (another object indicated by the program) closer to the right side of the room than subsystem 14 would mix the music in the absence of such listener data, thereby mixing the music toward the child and away from the adult (to prevent the music from interfering with the adult's ability to understand the dialog).

Typically, the listener data generated in accordance with the invention is indicative of position of at least one listener, and the inventive system (e.g., subsystem 14 of FIG. 1) is preferably configured to render an object based audio program indicative of at least two audio objects, including by generating speaker feeds for driving a set of loudspeakers to emit sound indicative of one of the audio objects intended to be perceived by one listener (at a first position) with balance and delay appropriate to a listener at the first position, and to emit sound indicative of another one of the audio objects intended to be perceived by another listener (at a second position) with balance and delay appropriate to a listener at the second position.

In another example, during playback of an object based audio program, image data from camera 8 visually indicates that each listener (e.g., both of listeners 1 and 2) is sitting on a couch and has fallen asleep. In response, subsystem 12 asserts listener data indicating that each listener has fallen asleep. In response to the listener data, subsystem 14 gradually turns down the audio playback level or turns off the audio (or, optionally, causes the FIG. 1 system to turn itself off).

The invention has many applications. For example, some embodiments of the invention are implemented in a gaming system (which includes a gaming console, a display device, and a speaker system) and other embodiments are implemented in a home theater system including a television (or other display device) and a speaker system).

In some embodiments, the inventive system includes a camera subsystem (e.g., camera 8 of FIG. 1) and a general or special purpose processor (e.g., an audio digital signal processor (DSP)) which is coupled to receive input audio data (indicative of an object based audio program) and is coupled to the camera subsystem, and is programmed with software (or firmware) and/or otherwise configured to perform an embodiment of the inventive method in response to the input audio data and image data provided by the camera subsystem. The processor may be programmed with software (or firmware) and/or otherwise configured (e.g., in response to control data) to perform any of a variety of operations on the input audio data, including an embodiment of the inventive method. For example, in some embodiments, the inventive system includes a general purpose processor, coupled to receive input audio (and optionally also input video) and the image data provided by the camera subsystem, and programmed to generate (by performing an embodiment of the inventive method) output data (e.g., output data determining speaker feeds) in response to the input audio and the image data. For example, the visual tracking subsystem and audio rendering subsystem of inventive system (e.g., elements 12, and 14 of FIG. 1) may be implemented as a general purpose processor programmed to generate such output data, and the system may include circuitry (e.g., within AVR 10 of FIG. 1) coupled and configured to generate speaker feeds determined by the output data. The circuitry could include a conventional digital-to-analog converter (DAC) coupled and configured to operate on the output data to generate analog speaker feeds for driving the speakers of a speaker array. In other embodiments, at least the audio rendering subsystem of inventive system (e.g., element 14 of FIG. 1) is or includes an appropriately configured (e.g., programmed and otherwise configured) audio digital signal processor (DSP) which is operable to generate output data (e.g., output data determining speaker feeds) in response to image data (from the system's camera subsystem) and input object based audio.

Aspects of the invention include a system configured (e.g., programmed) to perform any embodiment of the inventive method, and a computer readable medium (e.g., a disc or other tangible object) which stores code for implementing any embodiment of the inventive method.

In some embodiments of the inventive method, some or all of the steps described herein are performed simultaneously or in a different order than specified in the examples described herein. Although steps are performed in a particular order in some embodiments of the inventive method, some steps may be performed simultaneously or in a different order in other embodiments.

While specific embodiments of the present invention and applications of the invention have been described herein, it will be apparent to those of ordinary skill in the art that many variations on the embodiments and applications described herein are possible without departing from the scope of the invention described and claimed herein. It should be understood that while certain forms of the invention have been shown and described, the invention is not to be limited to the specific embodiments described and shown or the specific methods described.

What is claimed is:

1. A method for rendering an audio program comprising one or more audio objects for playback in an environment including a speaker array comprising at least one speaker, said method including the steps of:
(a) generating image data indicative of at least one listener in the environment;
(b) processing the image data to generate listener data indicative of at least one characteristic of at least one said listener; and
(c) rendering at least one of the audio objects in response to the listener data.

2. The method of claim 1, wherein the listener data is indicative of position of at least one said listener, and step (c) includes a step of generating at least one speaker feed for driving at least one speaker of the array to emit sound intended to be perceived by one said listener with balance and delay appropriate to the position of said listener.

3. The method of claim 1, wherein the listener data is indicative of a first position of a first listener and a second position of a second listener, the audio program comprises at least two audio objects, and step (c) includes a step of generating at least one speaker feed for driving at least one speaker of the array to emit first sound indicative of one of the audio objects and additional sound indicative of another one of the audio objects, wherein the first sound which is intended to be perceived by the first listener at the first position with balance and delay appropriate to a listener at said first position, and the additional sound is intended to be perceived by the second listener at the second position with balance and delay appropriate to a listener at said second position.

4. The method of claim 3, wherein the audio program is an object based audio program indicative of the at least two audio objects.

5. The method of claim 1, wherein the listener data is indicative of position and size of at least one said listener.

6. The method of claim 1, wherein the audio program includes metadata, and step (c) includes a step of rendering the audio program in response to the listener data and the metadata.

7. The method of claim 1, wherein step (c) includes a step of rendering the audio program in response to the listener data and in response to listener identification data.

8. The method of claim 7, wherein the listener identification data is indicative of hearing capability of at least one said listener.

9. The method of claim 8, wherein the listener data is indicative of position and size of at least one said listener, and step (c) includes a step of determining from the listener identification data and the listener data that one said listener whose size is indicated by the listener data has a hearing capability which is indicated by the listener identification data.

10. A system for rendering an audio program comprising one or more audio objects for playback in an environment including a speaker array comprising at least one speaker, said system including:
a camera subsystem, including at least one camera, wherein the camera subsystem is configured to generate image data indicative of at least one listener in a field of view of at least one camera of the camera subsystem;
a visual tracking subsystem coupled and configured to process the image data to generate listener data indicative of at least one listener characteristic; and
a rendering subsystem coupled and configured to render at least one of the audio objects in response to the listener data.

11. The system of claim 10, wherein the listener data is indicative of position of at least one said listener, and the rendering subsystem is configured to generate at least one speaker feed for driving at least one speaker of the array to emit sound intended to be perceived by one said listener with balance and delay appropriate to the position of said listener.

12. The system of claim 10, wherein the listener data is indicative of a first position of a first listener and a second position of a second listener, the audio program comprises at least two audio objects, and the rendering subsystem is configured to generate at least one speaker feed for driving at least one speaker of the array to emit first sound indicative of one of the audio objects and additional sound indicative of another one of the audio objects, wherein the first sound which is intended to be perceived by the first listener at the first position with balance and delay appropriate to a listener at said first position, and the additional sound is intended to be perceived by the second listener at the second position with balance and delay appropriate to a listener at said second position.

13. The system of claim 12, wherein the audio program is an object based audio program indicative of the at least two audio objects.

14. The system of claim 10, wherein the listener data is indicative of position and size of at least one said listener.

15. The system of claim 10, wherein the audio program includes metadata, and the rendering subsystem is configured to render the audio program in response to the listener data and the metadata.

16. The system of claim 10, wherein the rendering subsystem is configured to render the audio program in response to the listener data and in response to listener identification data.

17. The system of claim 16, wherein the listener identification data is indicative of hearing capability of at least one said listener.

18. The system of claim 17, wherein the listener data is indicative of position and size of at least one said listener, and the rendering subsystem is configured to determine from the listener identification data and the listener data that one said listener whose size is indicated by the listener data has a hearing capability which is indicated by the listener identification data.

19. The system of claim 10, including a processor coupled to the camera subsystem, wherein the processor is configured to implement both the visual tracking subsystem and the rendering subsystem.

20. A non-transitory computer readable storage medium that is readable by a device and that records a program of instructions executable by the device to perform a method for rendering an audio program comprising one or more audio objects for playback in an environment including a speaker array comprising at least one speaker, said method including the steps of:
(a) generating image data indicative of at least one listener in the environment;
(b) processing the image data to generate listener data indicative of at least one characteristic of at least one said listener; and
(c) rendering at least one of the audio objects in response to the listener data.
